(19) United States
(12) Patent Application Publication
(10) Pub. No.: US 2006/0055828 A1
(43) Pub. Date: Mar. 16, 2006

(54) Automatic gamma correction for a matrix display

(75) Inventors: John S. Henry, Sevierville, TN (US); Mark W Laramie, Knoxville, TN (US); Johnnes G.R Van Mourik, Chamonixlaan (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., Eindhoven (NL)

(21) Appl. No.: 10/538,617

(22) PCT Filed: Dec. 4, 2003
(86) PCT No.: PCT/IB03/05728

§ 371 Date: Jun. 10, 2005

Related U.S. Application Data
(60) Provisional application No. 60/433,364, filed on Dec. 13, 2002.

(51) Int. Cl. G09G 3/36

(52) U.S. Cl. 348/674; 348/602; 345/89

(57) ABSTRACT

In a display device having a matrix-type display, an automatic picture setting circuit includes a source for color video signals, and adjustable gamma correction circuits for each of the color video signals. Each of the adjustable gamma correction circuits has a control input for receiving a control signal for controlling an amount of gamma correction performed. In addition, the automatic picture setting circuit includes an ambient light sensing circuit for generating the control signal for the adjustable gamma correction circuits in dependence on a detected amount of ambient light. As such, the automatic picture setting circuit adapts a picture displayed on the display device to the amount of ambient light around the display device thereby assuring an optimum displayed picture.

### FIELD OF THE INVENTION

The subject invention relates to adjusting the picture settings of a matrix display in order to compensate for changes in the ambient light.

### DESCRIPTION OF THE RELATED ART

The observable quality of picture on a display is highly dependent on the amount of ambient light in the room containing the display. For example, in movie theaters, it is customary for the proprietor to lower, if not extinguish, the house lights in order to achieve the best possible picture. However, in a home environment, extinguishing the lights is not practicable. Rather, the display, for example, a television receiver contains controls accessible by the user for adjusting the picture to compensate for the amount of ambient light. This ordinarily involves adjusting the contrast of the displayed picture. Since the room lighting may change over the course of time, it is necessary for the user to repeatedly adjust the contrast of the displayed picture.

U.S. Pat. No. 4,769,708 discloses a manual and automatic ambient light sensitive picture control for a television receiver in which a sensor measures the amount of ambient light and adjusts the contrast of the displayed picture accordingly. In this television receiver, the display device is a cathode ray tube.

Applicants have found that in the case of a display with limited light output, for example, a liquid crystal display (LCD) or a plasma display panel, adjusting the contrast leads to a degradation in the picture quality.

It is an object of the invention to provide automatic picture setting adjustment for a matrix type display to compensate for changes in the ambient light. This object is achieved in an automatic picture setting adjustment circuit comprising a source for color video signals; adjustable gamma correction circuits for each of said color signals, each of said adjustable gamma correction circuits having a control input for receiving a control signal for controlling an amount of gamma correction performed; and an ambient light sensing circuit for generating the control signal in dependence on a detected amount of ambient light.

Applicants have found that in a matrix type display it is best to maintain the contrast at an optimum setting. Rather, in order to adjust the gray level to luminance, gamma correction should instead be adjusted. Gamma correction is the voltage level to luminance level transfer function that is applied to a video signal. Gamma correction compensates for differences in the overall end-to-end linearity of light functions. Video signals already contain a fixed amount of gamma correction that is utilized by cathode ray tubes. For a matrix display, this fixed amount of gamma correction is removed and an appropriate amount of gamma correction is then added to the video signals. By varying the amount of gamma correction in dependence on the ambient light, the picture quality may be adjusted to achieve the best possible picture.

With the above and additional objects and advantages in mind as will hereinafter appear, the invention will be described with reference to the accompanying drawings, in which:

FIG. 1 shows a first embodiment of the automatic picture setting adjustment circuit in accordance with the invention;

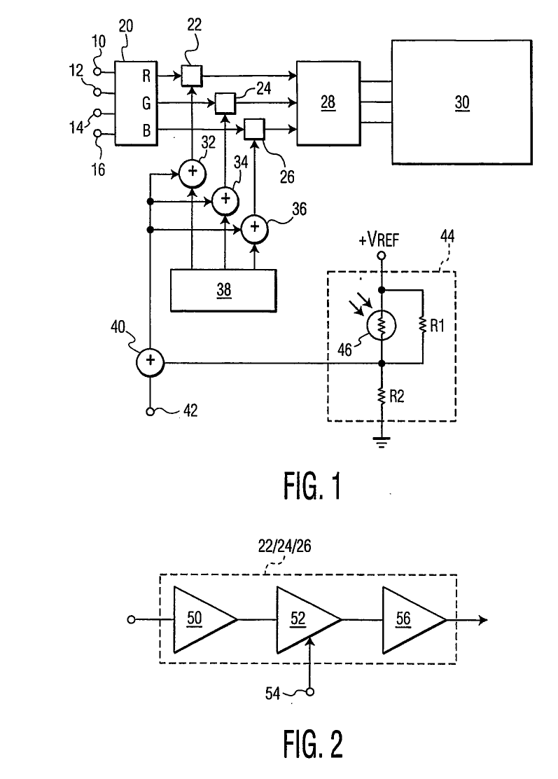

FIG. 2 shows an embodiment of an adjustable gamma correction circuit; and

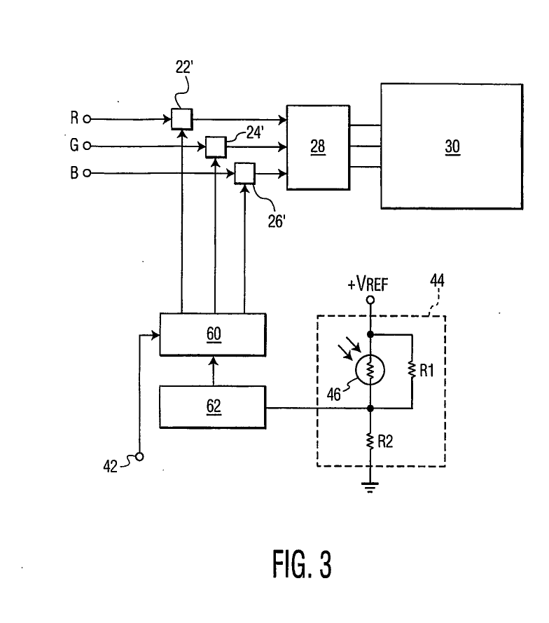

FIG. 3 shows a second embodiment of the automatic picture setting adjustment circuit in accordance with the invention.

As shown in FIG. 1, inputs 10, 12, 14 and 16 receive a luminance signal Y and color difference signal R-Y, B-Y and G-Y, respectively. A matrix circuit 20 generates color video signals R, G and B from the luminance and color difference signals. The color video signals are applied to respective adjustable gamma correction circuits 22, 24 and 26. The outputs from these adjustable gamma correction circuits are applied to a display driving circuit 28 for providing the driving signals for a matrix type display 30.

The adjustable gamma correction circuits 22, 24 and 26 have gamma control inputs connected to the outputs of adder circuits 32, 34 and 36 which receive, at respective first inputs, preset gamma control signals from presetting circuit 38. The second inputs of adder circuits 32, 34 and 36 are collectively connected to the output of another adder circuit 40 which receives a user gamma control signal at user input 42 indicative of a user setting of the overall gamma correction. In addition, the adder circuit 4 40 receives an ambient light gamma control signal from an ambient light sensing circuit 44. The ambient light sensing circuit 44 includes the parallel arrangement of a light sensor 46 and a resistor R1, arranged in series with a second resistor R2 between a reference voltage source+V_{REF} and ground.

In operation, the manufacturer of a display device incorporating the subject invention pre-adjusts the correction levels of each of the adjustable gamma correction circuits 22, 24 and 26, using the presetting circuit 38. A user of the display device may then achieve a degree of adjustment of the overall gamma correction by operating a user control (not shown) connected to the user input. Finally, the ambient light sensing circuit 44, in which the light sensor 46 is arranged conveniently to detect the ambient light outside of the cabinet of the display device, applies a variable ambient light gamma control signal to the adder 40 depending on the amount of ambient light.

An embodiment of the adjustable gamma correction circuits 22, 24 and 26 is shown in U.S. Pat. No. 5,889,565. In particular, as shown in FIG. 2, the video signal is applied a log amplifier 50. A variable gain amplifier 52 has an input connected to the output of the log amplifier 50 and a control input 54 for receiving the gamma control value. Finally, an anti-log amplifier 56 has an input connected to an output of the variable gain amplifier 52 and an output for supplying the gamma corrected video signal. While each of these components are separately available, it has been found that in order for the log and anti-log amplifiers 50 and 56 to cooperate properly, they must be maintained at the same temperature. Hence, the log and anti-log amplifiers 50 and 56 should be formed on a same integrated circuit chip. To that end, it would be convenient to form the variable gain amplifier 52 on the same chip. As a further convenience, all of the adjustable gamma correction circuits 22, 24 and 26 may be formed on the same integrated circuit chip.

FIG. 3 shows a second embodiment of the automatic picture setting adjustment circuit. In particular, the adjustable gamma correction circuits 22′, 24′ and 26′ are in the form of look-up tables (LUT), wherein the color video signals R, G, B are applied as address signals. The LUTs 22′, 24′ and 26′ are coupled to a microprocessor 60 which then sets the appropriate gamma setting in the LUT's 22′, 24′ and 26′. In one embodiment, each of the LUTs 22′, 24′ and 26′ contain a plurality of gamma value tables and the microprocessor 60 selects the appropriate table to be addressed by the respective color signal. In order to limit the necessary size of each of the LUTs 22′, 24′ and 26′, another embodiment, the microprocessor 60 calculates the appropriate gamma values for each of the LUT's 22′, 24′ and 26′ and then loads these values into the LUTs 22′, 24′ and 26′. It should be appreciated that the presetting circuit 38 of FIG. 1 is now incorporated in the microprocessor 60. User input 42 is also connected to the microprocessor 60 and applies a user control signal indicative of a user's desired overall setting of the gamma correction. Finally, ambient light sensing circuit 44 is connected to the microprocessor 60 via another look-up table (LUT) 62 which translates the voltage signal into a gamma correction code for the microprocessor 60.

Numerous alterations and modifications of the structure herein disclosed will present themselves to those skilled in the art. However, it is to be understood that the above described embodiment is for purposes of illustration only and not to be construed as a limitation of the invention. All such modifications which do not depart from the spirit of the invention are intended to be included within the scope of the appended claims.

1. An automatic picture setting adjustment circuit comprising:
a source (20) for color video signals;
adjustable gamma correction circuits (22, 24, 26) for each of said color video signals, each of said adjustable gamma correction circuits having a control input for receiving a respective gamma control signal for controlling an amount of gamma correction performed;
an ambient light sensing circuit (44) for generating a gamma adjusting signal in dependence on a detected amount of ambient light; and
means (32, 34, 36, 40, 60) for generating said respective gamma control signals from said gamma adjusting signal.

2. The automatic picture setting adjustment circuit as claimed in claim 1, wherein said source (20) for color signals comprises a matrix circuit for receiving color difference signals and a luminance signal, said matrix circuit generating said color video signals.

3. The automatic picture setting adjustment circuit as claimed in claim 1, wherein said automatic picture setting adjustment circuit further comprises a presetting circuit (38) for providing pre-set signals indicative of an initial operating condition for each of said adjustable gamma correction circuits, said generating means (32, 34, 36, 40, 60) generating said respective gamma control signals from said pre-set signals and said gamma adjusting signal.

4. The automatic picture setting adjustment circuit as claimed in claim 1, wherein said automatic picture setting adjustment circuit further comprises a user input (42) for supplying a user control signal indicative of a desired overall setting by a user, said generating means (32, 34, 36, 40, 60) generating said respective gamma control signals from said user control signal and said gamma adjusting signal.

5. The automatic picture setting adjustment circuit as claimed in claim 1, wherein each of said adjustable gamma correction circuits (22, 24, 26) comprises a serial arrangement of a log amplifier (50) for receiving the color video signal, a variable gain amplifier (52) coupled to an output of the log amplifier (50), said variable gain amplifier (52) having a control input (54) for receiving the respective gamma control signal, and an anti-log amplifier (56) coupled to an output of the variable gain amplifier (52), an output of the anti-log amplifier (56) forming an output of the adjustable gamma correction circuit.

6. The automatic picture setting adjustment circuit as claimed in claim 5, wherein said source (20) for color signals comprises a matrix circuit for receiving color difference signals and a luminance signal, said matrix circuit generating said color video signals.

7. The automatic picture setting adjustment circuit as claimed in claim 5, wherein said automatic picture setting adjustment circuit further comprises a presetting circuit (38) for providing pre-set signals indicative of an initial operating condition for each of said adjustable gamma correction circuits, said generating means (32, 34, 36, 40) generating said respective gamma control signals from said pre-set signals and said gamma adjusting signal.

8. The automatic picture setting adjustment circuit as claimed in claim 5, wherein said automatic picture setting adjustment circuit further comprises a user input (42) for supplying a user control signal indicative of a desired overall setting by a user, said generating means (32, 34, 36, 40) generating said respective gamma control signals from said user control signal and said gamma adjusting signal.

9. The automatic picture setting adjustment circuit as claimed in claim 1, wherein each of said adjustable gamma correction circuits comprise a look-up table (22′, 24′, 26′) in which the respective color video signal is applied to an address input, and said generating means comprises a microprocessor (60) for calculating the gamma values as said respective gamma control signals for application to the adjustable gamma correction circuits.

10. The automatic picture setting adjustment circuit as claimed in claim 9, wherein said automatic picture setting adjustment circuit further comprises a user input (42) for supplying a user control signal indicative of a desired overall setting by a user, said microprocessor (60) generating said gamma values from said user control signal and said gamma adjusting signal.
